(19) United States
(12) Patent Application Publication
(10) Pub. No.: US 2018/0136069 A1
(43) Pub. Date: May 17, 2018

(54) FLUID EQUIPMENT

(71) Applicant: HORIBA STEC, Co., Ltd., Kyoto-shi (JP)

(72) Inventors: Hideaki Miyamoto, Kyoto-shi (JP); Masaki Inoue, Kyoto-shi (JP); Ichiro Nishikawa, Kyoto-shi (JP); Masashi Hamada, Kyoto-shi (JP); Takehisa Hataita, Kyoto-shi (JP); Sotaro Kishida, Kyoto-shi (JP); Hidetaka Yada, Irvine, CA (US)

(21) Appl. No.: 15/811,342

(22) Filed: Nov. 13, 2017

(30) Foreign Application Priority Data
Nov. 14, 2016 (JP) 2016-221518

(51) Int. Cl. G01L 19/06; G01L 19/14; G01L 19/00

(52) U.S. Cl. CPC G01L 19/0609; G01L 19/0038; G01L 19/146

(57) ABSTRACT

In order to reduce an excessive pressure applied to a pressure sensor due to thermal expansion of fluid or the like, fluid equipment includes: a body unit formed with an internal flow path through which liquid flows; a pressure sensor provided on the body unit for sensing the pressure in the internal flow path; and a fluctuation absorbing part provided on the body unit for absorbing pressure fluctuation of the fluid.

### TECHNICAL FIELD

The present invention relates to fluid equipment having a pressure sensor mounted thereon.

### BACKGROUND ART

As fluid equipment having a pressure sensor mounted thereon, there is, for example, a differential pressure flowmeter. In this flowmeter, a fluid resistance element is provided in a flow path through which fluid flows, and pressure sensors are provided respectively on an upstream side and a downstream side of the fluid resistance element, so that a flow rate of the fluid is measured based on a differential pressure between the upstream side pressure sensor and the downstream side pressure sensor.

In a fluid circuit incorporating such a differential pressure flowmeter, on-off valves are provided respectively in the upstream side and downstream side of the flowmeter in some cases, and in the case where fluid is not allowed to flow into the flowmeter, the on-off valves in the upstream side and downstream side are closed.

However, in the case where a temperature of the fluid rises in this state, the fluid thermally expands and the pressure in the tightly closed space between the on-off valves is increased. This increased pressure causes an excessive pressure exceeding, for example, an allowable overpressure to be applied to components such as a pressure sensor of the flowmeter, resulting in damaging the components. As a result, there occur, for example, a failure of the components, a zero point change, and a span change.

### CITATION LIST

### Patent Literature

Patent Literature 1: JP-A-2008-196858

### SUMMARY OF INVENTION

### Technical Problem

Therefore, the present invention has been made to solve the problems mentioned above, and a main object thereof is to reduce an excessive pressure applied to a pressure sensor due to thermal expansion of fluid and the like.

### Solution to Problem

That is, fluid equipment includes: a body unit formed with an internal flow path through which liquid flows; a pressure sensor provided on the body unit for sensing a pressure in the internal flow path; and a fluctuation absorbing part provided on the body unit for absorbing pressure fluctuation of the fluid.

With this fluid equipment, since the fluctuation absorbing part provided on the body unit absorbs the pressure fluctuation caused by thermal expansion of the fluid or the like, it is possible to suppress increase of the pressure in the internal flow path due to thermal expansion of the fluid or the like. Thus, excessive pressure applied to the pressure sensor can be reduced, and it is possible to reduce damages to the pressure sensor due to the pressure fluctuation caused by the thermal expansion of the fluid or the like.

Here, it is preferable that the fluctuation absorbing part is adapted to absorb thermal expansion of the fluid.

As a configuration for making an effect of the present invention remarkable, it is conceivable that the pressure sensor is adapted to sense the pressure using a diaphragm that deforms in accordance with a change in pressure in the internal flow path. Since the diaphragm is easily deformed under an influence of the pressure fluctuation caused by thermal expansion of the fluid or the like, the effect of providing the fluctuation absorbing part becomes remarkable.

As a specific configuration of the fluid equipment, a differential pressure flowmeter is conceivable. In the case of this differential pressure flowmeter, it is configured that a fluid resistance element is provided in the internal flow path and that the pressure sensor includes an upstream side pressure sensor that is provided on an upstream side of the fluid resistance element and a downstream side pressure sensor that is provided in a downstream side of the fluid resistance element. Further, the differential pressure flowmeter is provided with a flow rate control valve in the downstream side thereof and constitutes a flow rate control device together with the flow rate control valve.

In this configuration, in the case where the fluctuation absorbing part is provided in the downstream side of the fluid resistance element, the fluctuation absorbing part acts as a buffer (shock absorber), and this results in deteriorating the responsiveness of the flow rate control by the flow rate control valve.

Therefore, in order to reduce the damage to the pressure sensor due to the thermal expansion without deteriorating the responsiveness of the flow rate control by the flow rate control valve, it is preferable that the fluctuation absorbing part is provided in the upstream side of the upstream side pressure sensor or the fluid resistance element.

Meanwhile, in some cases, the differential pressure flowmeter may be also provided with the flow rate control valve in the upstream side thereof and constitute the flow rate control device together with the flow rate control valve. In this case, it is preferable that the fluctuation absorbing part is provided in the downstream side of the downstream side pressure sensor or the fluid resistance element.

In order to easily provide the fluctuation absorbing part on the body unit, it is preferable that the fluctuation absorbing part is attached to an outer surface of the body unit.

In order to simplify the configuration of the fluctuation absorbing part, it is preferable that the fluctuation absorbing part includes a diaphragm that deforms in accordance with the pressure fluctuation of the fluid.

In order to make the diaphragm of the fluctuation absorbing part easily deformable due to pressure fluctuation caused by thermal expansion of the fluid or the like, it is preferable that the diaphragm of the fluctuation absorbing part includes a wave shape portion having a ring shape in plan view and a waveform shape in cross-section.

In order to prevent breakage due to plastic deformation of the diaphragm and ensure safety of the fluid equipment, it is preferable that the fluctuation absorbing part includes a deformation restricting part that is provided in a swelled side caused by the deformation of the diaphragm, at a predetermined distance from the diaphragm.

### Advantageous Effects of Invention

According to the present invention, since the fluctuation absorbing part provided on the body unit absorbs pressure fluctuation caused by thermal expansion of the fluid or the like, it is possible to reduce an excessive pressure applied to the pressure sensor due to pressure fluctuation caused by thermal expansion of the fluid or the like.

### BRIEF DESCRIPTION OF DRAWINGS

FIG. 1 is a cross-sectional view schematically showing a configuration of a flowmeter of the present embodiment;

FIG. 2 is a partially enlarged view schematically showing a configuration of a fluctuation absorbing part of the same embodiment;

FIG. 3 is a plan view showing a configuration of a diaphragm of the same embodiment;

FIG. 4 is a schematic diagram showing an action of the fluctuation absorbing part of the same embodiment;

FIG. 5 is a cross-sectional view schematically showing a modified example of installation of the fluctuation absorbing part;

FIG. 6 is a cross-sectional view schematically showing a modified example of the fluctuation absorbing part;

FIG. 7 is a cross-sectional view schematically showing a modified example of the fluctuation absorbing part;

FIG. 8 is a cross-sectional view schematically showing a modified example of the fluctuation absorbing part; and

FIG. 9 is a cross-sectional view schematically showing a modified example of the fluctuation absorbing part.

### DESCRIPTION OF EMBODIMENTS

One embodiment of a flowmeter according to the present invention will be described below with reference to the accompanying drawings.

A flowmeter 100 of the present embodiment is used, for example, in a semiconductor manufacturing process.

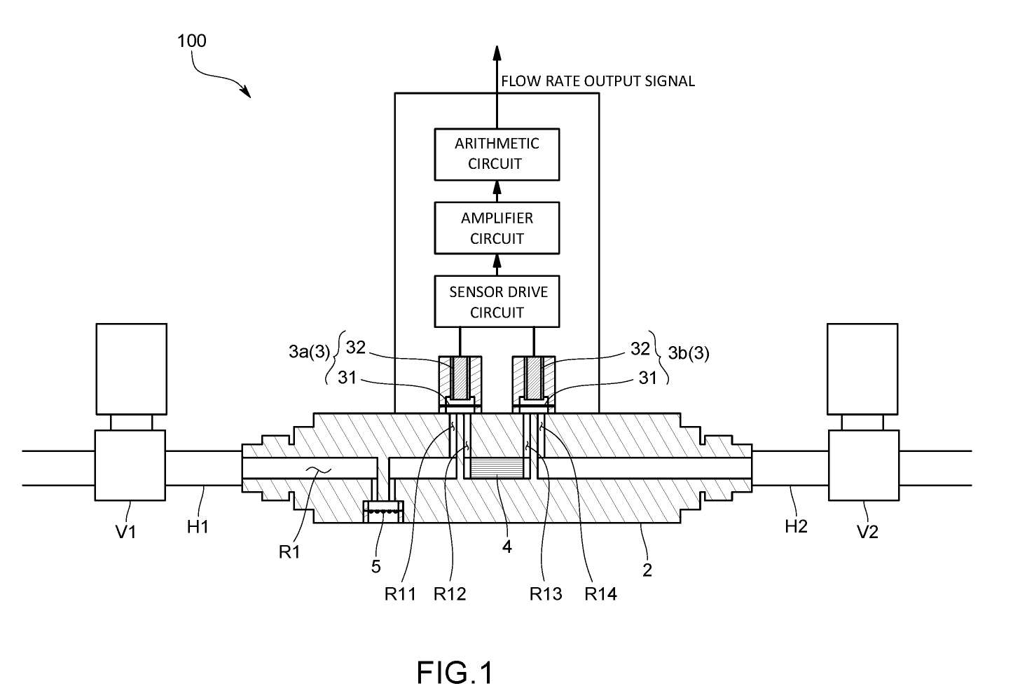

Specifically, as shown in FIG. 1, the flowmeter 100 includes: a body unit 2 formed with an internal flow path R1 through which liquid, such as liquid for a semiconductor process, flows; and a pressure sensor 3 which is provided on the body unit 2 and senses pressure in the internal flow path R1. The body unit 2 is formed of a material having corrosion resistant to the liquid, and for example, made of stainless steel. In addition, a liquid-contacting member such as the pressure sensor 3 is also formed of a material having corrosion resistant to the liquid, and for example, made of stainless steel.

The body unit 2 has a block shape through which the internal flow path R1 penetrates. In the middle of the internal flow path R1, a fluid resistance element 4 such as a laminar flow element or an orifice is provided. Further, an external inflow pipe H1 is connected to one end part of the flow path located on an upstream side of the body unit 2. An external outflow pipe H2 is connected to the other end part of the flow path located on a downstream side of the body unit 2. In addition, the external inflow pipe H1 and the external outflow pipe H2 are made of a material having higher rigidity than a diaphragm 31 of the pressure sensor 3. And the external inflow pipe H1 and the external outflow pipe H2 are provided with on-off valves V1 and V2 respectively, such as pneumatic valves and solenoid valves.

The pressure sensor 3 senses pressure using the diaphragm 31 that deforms in accordance with a change in pressure in the internal flow path R1. The pressure sensor 3 of the present embodiment is a capacitance type pressure sensor that measures the pressure by detecting an electrostatic capacitance between the diaphragm 31 and a fixed electrode 32 provided apart from the diaphragm 31.

The pressure sensor 3 includes an upstream side pressure sensor 3a that is provided in the upstream side of the fluid resistance element 4 and a downstream side pressure sensor 3b that is provided in the downstream side of the fluid resistance element. In this configuration, the upstream side pressure sensor 3a is attached to the body unit 2 so as to cover openings of an upstream introduction path R11 and an upstream lead-out path R12 formed in the body unit 2. Further, the downstream side pressure sensor 3b is attached to the body unit 2 so as to cover openings of a downstream introduction path R13 and a downstream lead-out path R14 formed in the body unit 2. Each of the upstream introduction path R11, the upstream lead-out path R12, the downstream introduction path R13, and the downstream lead-out path R14 is formed so as to be opened in one surface of the body unit 2 in the vicinity of the fluid resistance element 4 in the internal flow path R1. In this configuration, the upstream side pressure sensor 3a and the downstream side pressure sensor 3b are driven by a sensor drive circuit, and detection signals indicating the electrostatic capacitance obtained by each of the sensors 3a and 3b are amplified by an amplifier circuit. Then, the amplified signals are converted into a flow rate by an arithmetic circuit.

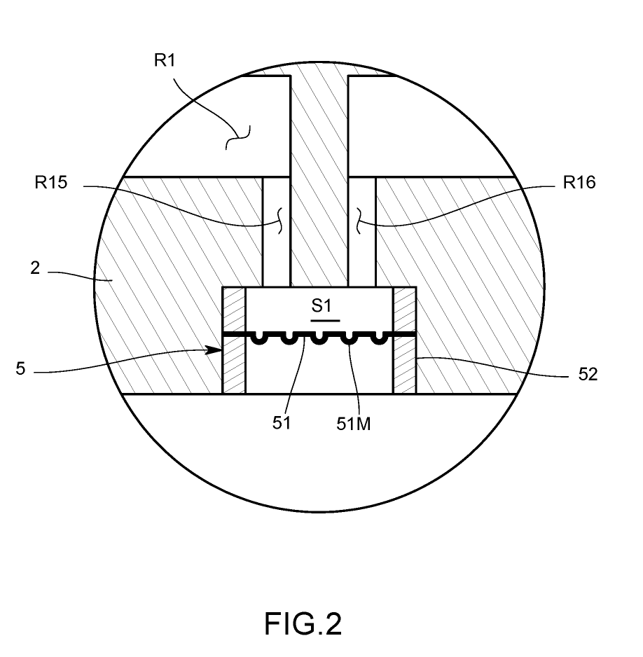

Thus, specifically as shown in FIG. 2, in the body unit 2 of the present embodiment, a fluctuation absorbing part 5 (also, referred to as “thermal expansion absorbing part 5”, hereinafter) for absorbing pressure fluctuation caused by thermal expansion and the like of the fluid flowing in the internal flow path is provided.

This thermal expansion absorbing part 5 is provided in the upstream side of the upstream side pressure sensor 3a and the fluid resistance element 4, and it includes a diaphragm 51 that deforms in accordance with thermal expansion of the fluid and a supporting body 52 for supporting the diaphragm 51. Incidentally, unlike the pressure sensor 3, the thermal expansion absorbing part 5 is not adapted to measure the pressure. In order to facilitate the arrangement of the thermal expansion absorbing part 5 together with the other components, the thermal expansion absorbing part 5 of the present embodiment is built in a region different from the surface (specifically, upper surface) of the body unit 2 on which the pressure sensor 3 is provided but it is built in a lower surface side of the body unit 2. Note that the thermal expansion absorbing part 5 may be of course built in the surface side (upper surface side) of the body unit 2 on which the pressure sensor 3 is provided.

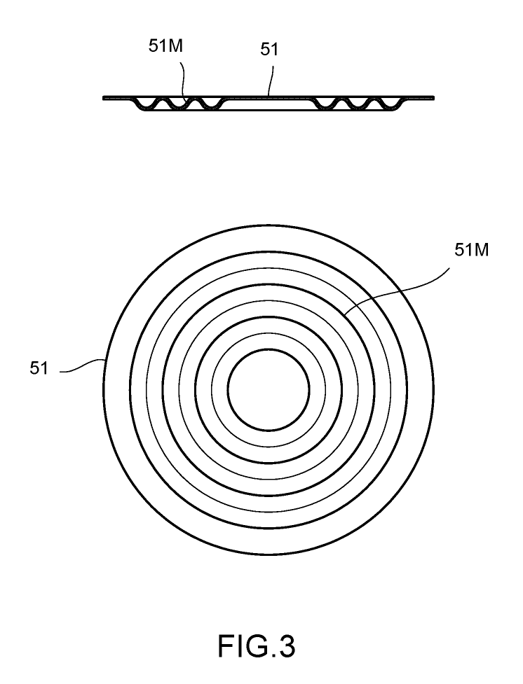

The diaphragm 51 is configured to be more easily deformable than the diaphragm 31 of the pressure sensor described above. Specifically, as shown in FIG. 3, the diaphragm 51 includes a wave shape portion 51M having a ring shape in plan view and a waveform shape in cross-section. The wave shape portion 51M is formed by providing a plurality of annular convex portions or concave portions concentrically.

The diaphragm 51 is provided in a state of facing a communication space S1 communicating with the internal flow path R1 (see FIG. 2). The communication space S1 of the present embodiment is formed by the supporting body 52, and this space S1 is communicated with the internal flow path R1 through an introduction path R15 and a lead-out path R16. Note that the diaphragm 51 may be provided in a state of directly facing the internal flow path R1.

In this configuration, in order to make the diaphragm 51 easily deformable, it is preferable that an opposite side of a surface on the side of the communication space of the diaphragm 51 is open to the atmosphere. Further, in order to increase a deformation amount of the diaphragm 51, it is preferable that the opposite side of the surface on the side of the communication space of the diaphragm 51 is pressurized and previously deformed toward the side of the communication space. As a configuration of deforming the diaphragm 51 toward the side of the communication space, it is conceivable that there are a configuration of deforming the diaphragm 51 by pressurizing the same with gas, a configuration of deforming the diaphragm 51 by pressurizing the same using an elastic restoring force of an elastic body such as a spring or rubber, or the like.

Next, an operation of this thermal expansion absorbing part will be described below.

In a state that the upstream side on-off valve V1 and the downstream side on-off valve V2 respectively provided in the upstream side and the downstream side of the flowmeter 100 are closed, the flow path between the upstream side on-off valve V1 and the downstream side on-off valve V2, including the internal flow path R1 becomes in a tightly closed state.

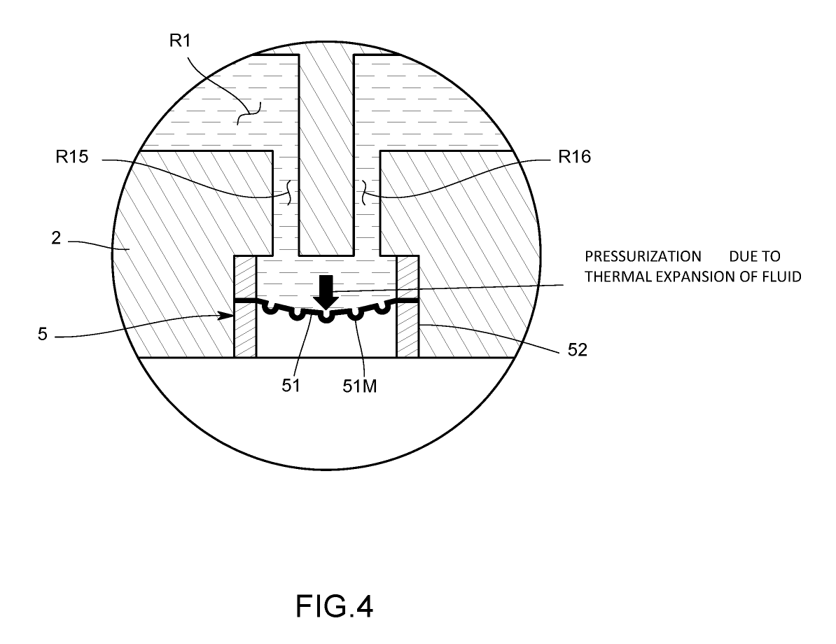

In this state, in the case where a temperature of the fluid in the tightly closed flow path rises, the fluid thermally expands. This expanded volume tends to escape to a flexible portion in the tightly closed flow path. In this configuration, the flexible portion includes the diaphragm 31 composed of the upstream side pressure sensor 3a and the downstream side pressure sensor 3b and the diaphragm 51 in the thermal expansion absorbing part 5. However, since the diaphragm 51 in the thermal expansion absorbing part 5 is more deformable than the diaphragm 31, most of the expanded volume is absorbed by deformation toward the opposite side (i.e., toward the atmosphere open side in this embodiment) to the flow path of the diaphragm 51 in the thermal expansion absorbing part 5 (see FIG. 4).

According to the flowmeter 100 configured as described above, since the thermal expansion absorbing part 5 provided in the body unit 2 absorbs the thermal expansion of the fluid, it is possible to suppress the increase of the pressure in the internal flow path R1 caused by the thermal expansion of the fluid. Thus, excessive pressure applied to the pressure sensor 3 can be reduced and damage to the pressure sensor 3 due to the thermal expansion of the fluid can be reduced. Further, since the thermal expansion absorbing part 5 is incorporated inside the body unit 2, the flowmeter 100 can be downsized.

It should be noted that the present invention is not limited to the embodiment mentioned above.

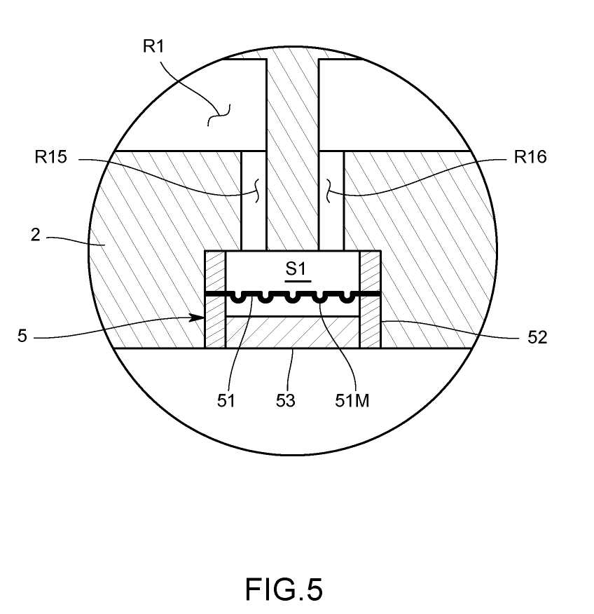

For example, as shown in FIG. 5, the thermal expansion absorbing part 5 may include a deformation restricting part 53 provided in the swelled side caused by the deformation of the diaphragm 51 and spaced apart from the diaphragm 51 by a predetermined distance. In the case where the diaphragm 51 deforms and swells by a predetermined amount or more, the deformation restricting part 53 is adapted to contact the swelled portion and restrict further deformation. Specifically, the deformation restricting part 53 is configured by a flat plate member.

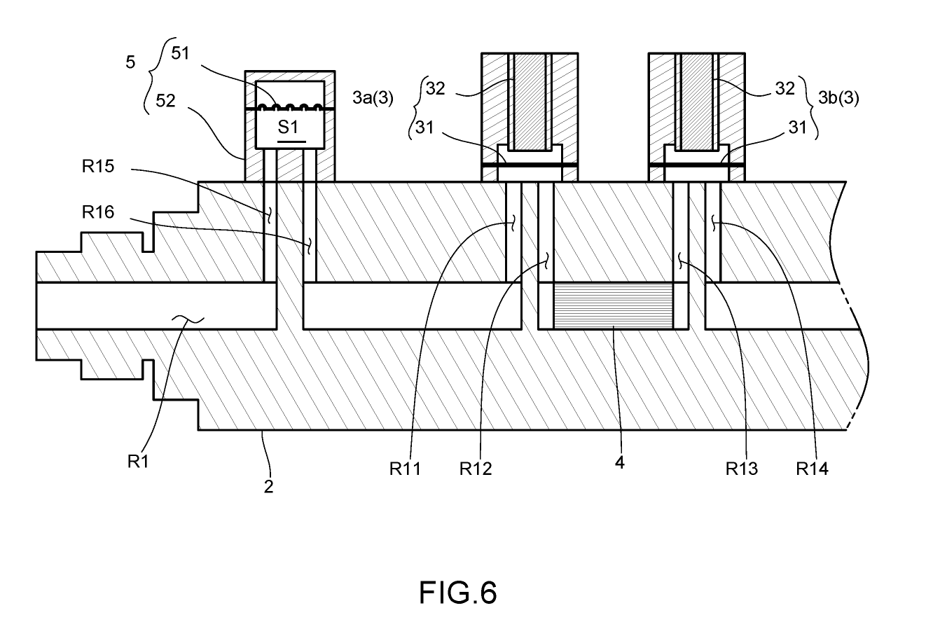

Further, in the embodiment mentioned above, although the thermal expansion absorbing part 5 is built and incorporated in the body unit 2, the thermal expansion absorbing part 5 may be configured to be attached to an outer surface of the body unit 2 without being built therein as shown in FIG. 6. In this case, the thermal expansion absorbing part 5 is attached to the body unit 2 so as to cover the openings of the introduction path R15 and the lead-out path R16 formed in the body unit 2. With this configuration, the thermal expansion absorbing part 5 can be easily attached to the body unit 2 without necessity of built-in processing to the body unit. Further, in order to reduce an installation space of the fluid equipment, it is preferable that the thermal expansion absorbing part 5 is provided on the same surface as each of the pressure sensors 3a and 3b.

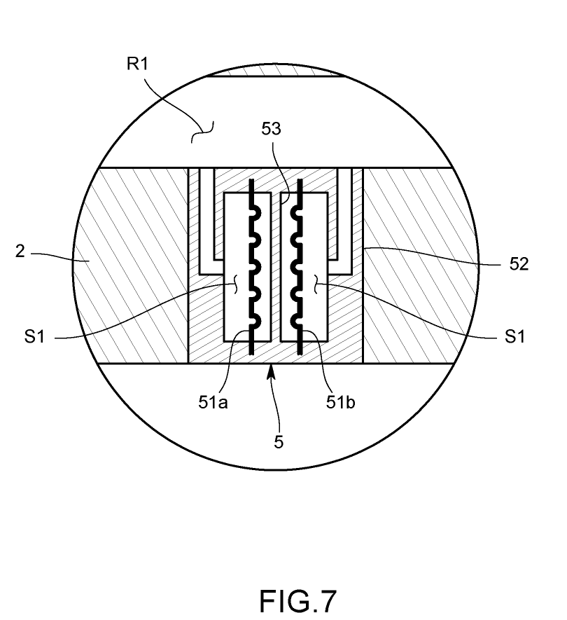

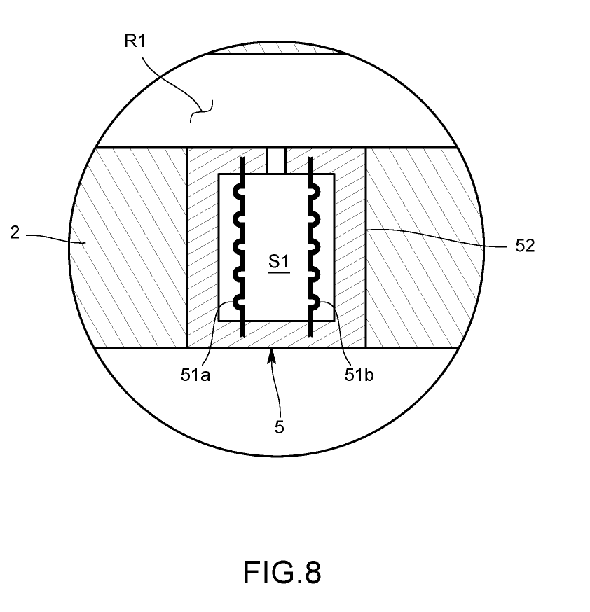

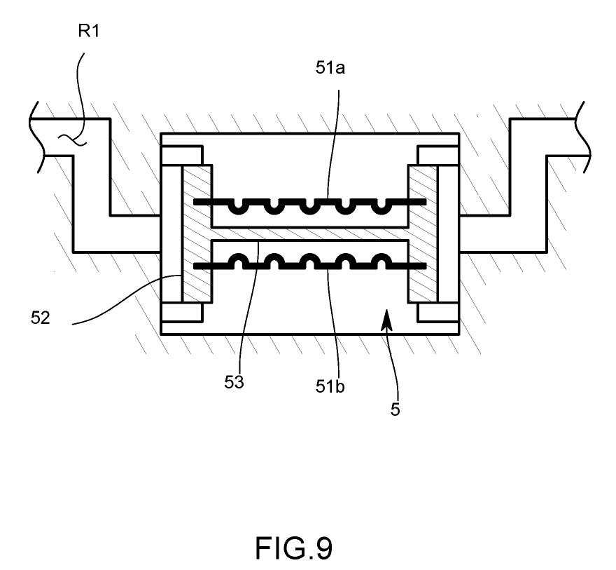

Further, although the thermal expansion absorbing part 5 of the embodiment mentioned above includes one diaphragm 51, in order to increase the absorbable expansion amount, the thermal expansion absorbing part 5 may include two or more diaphragms as shown in FIGS. 7 to 9. In the configurations of the thermal expansion absorbing part 5 shown in FIGS. 7 and 9, two diaphragms 51a and 51b are disposed facing each other and the surroundings thereof are filled with fluid, so that the diaphragms 51a and 51b are deformable inward. In the configuration of the thermal expansion absorbing part 5 shown in FIG. 8, two diaphragms 51a and 51b are disposed facing each other and a space between the two diaphragms 51a and 51b is filled with fluid, so that the diaphragms 51a and 51b are deformable outward. In the configurations shown in FIGS. 7 and 8, the thermal expansion absorbing part 5 is provided in a flow path branched from the internal flow path R1, and FIG. 8 shows a configuration of providing the thermal expansion absorbing part 5 on the internal flow path R1. In the configurations of FIGS. 7 and 9, although the deformation restricting part 53 is provided between the two diaphragms 51a and 51b, it may be configured that, without providing the deformation restricting part 53, in the case where the two diaphragms 51a and 51b are deformed by a predetermined amount, the two diaphragms 51a and 51b are contacted to each other and one of the two diaphragms may exhibit a function as a deformation restricting part for the other.

Although the thermal expansion absorbing part of the embodiment mentioned above is configured of a diaphragm, any mechanism may be used so long as it has a deformable member that deforms in accordance with thermal expansion and absorbs the corresponding expansion amount by the deformable member, it may be configured using, for example, a bellows.

Further, although the fluid equipment 100 of the embodiment mentioned above is a flowmeter having the pressure sensor 3 mounted on the body unit 2, in addition to this, it may be a mass flow controller having a flow rate control valve mounted thereto. Also, it may be configured by providing a pressure sensor on the fluid equipment in which other types of a flow rate measuring mechanism such as a thermal type flowmeter, a Coriolis type flowmeter, an ultrasonic type flowmeter, or the like is provided.

Further, in the case of a fluid circuit where a flow rate control valve cannot be provided in the downstream side of the fluid equipment, the thermal absorbing part may be provided in the downstream side of the downstream side pressure sensor 3b or the fluid resistance element 4.

Although the fluctuation absorbing part exhibits a main function as the thermal expansion absorbing part, otherwise it may be also adapted to absorb pressure fluctuation of the fluid caused in the case of closing the on-off valves V1 and V2.

Although the pressure sensor of the embodiment mentioned above is electrostatic capacitance type one, it may be also strain gauge type one provided with a strain gauge on the diaphragm, or it may be also piezoelectric type (piezo-type) one provided with a piezoelectric element on the diaphragm.

As the flow rate measuring mechanism of the embodiment mentioned above, various flow rate measuring systems such as pressure type one, Coriolis type one, ultrasonic type one, and the like can be used besides the thermal type one.

The fluid equipment of the embodiment mentioned above may be also used for processes other than the semiconductor manufacturing processes.

It is needless to say that the present invention is not limited to each of the embodiments mentioned above, and various modifications thereof can be made in a range without departing from the spirit thereof.

### LIST OF REFERENCE CHARACTERS

100 . . . Fluid equipment
2 . . . Body unit
R1 . . . Internal flow path
3 . . . Pressure sensor
31 . . . Diaphragm
3a . . . Upstream side pressure sensor
3b . . . Downstream side pressure sensor
4 . . . Fluid resistance element
5 . . . Thermal expansion absorbing part
51 . . . Diaphragm
51M . . . Wave shape portion

1. Fluid equipment comprising: a body unit formed with an internal flow path through which liquid flows;
a pressure sensor provided on the body unit for sensing a pressure in the internal flow path; and
a fluctuation absorbing part provided on the body unit for absorbing pressure fluctuation of the fluid.

2. The fluid equipment according to claim 1, wherein the fluctuation absorbing part is adapted to absorb thermal expansion of the fluid.

3. The fluid equipment according to claim 1, wherein the pressure sensor is adapted to sense the pressure using a diaphragm that deforms in accordance with a change in pressure in the internal flow path.

4. The fluid equipment according to claim 1, wherein a fluid resistance element is provided in the internal flow path, wherein the pressure sensor includes an upstream side pressure sensor that is provided on an upstream side of the fluid resistance element and a downstream side pressure sensor that is provided in a downstream side of the fluid resistance element, and wherein the fluctuation absorbing part is provided in the upstream side of the upstream side pressure sensor or the fluid resistance element.

5. The fluid equipment according to claim 1, wherein the fluctuation absorbing part is attached to an outer surface of the body unit.

6. The fluid equipment according to claim 1, wherein the fluctuation absorbing part includes a diaphragm that deforms in accordance with the pressure fluctuation of the fluid.

7. The fluid equipment according to claim 6, wherein the diaphragm of the fluctuation absorbing part includes a wave shape portion having a ring shape in plan view and a waveform shape in cross-section.

8. The fluid equipment according to claim 6, wherein the fluctuation absorbing part includes a deformation restricting part that is provided in a swelled side caused by the deformation of the diaphragm, at a predetermined distance from the diaphragm.
